(19) United States
(12) Patent Application Publication
(10) Pub. No.: US 2011/0317031 A1
(43) Pub. Date: Dec. 29, 2011

(54) IMAGE PICKUP DEVICE

(75) Inventor: Hiroaki HONDA, Daito-shi (JP)

(73) Assignee: Kyocera Corporation, Kyoto (JP)

(21) Appl. No.: 13/168,909

(22) Filed: Jun. 24, 2011

(30) Foreign Application Priority Data
Jun. 25, 2010 (JP) 2010-145206

(51) Int. Cl. H04N 5/235; H04N 5/76

(52) U.S. Cl. 348/229.1; 348/231.99; 348/E05.037

(57) ABSTRACT

A system and method for picking up an image is disclosed. Through images are captured repeatedly until a shutter condition is satisfied, and an object is detected in the through images. It is decided whether the shutter condition is satisfied, if the object is within a face-capture region of at least one of the through images, and an image is captured for recording, if the shutter condition is satisfied.

### CROSS-REFERENCE TO RELATED APPLICATION

The present application claims priority under 35 U.S.C. §119 to Japanese Patent Application No. 2010-145206, filed on Jun. 25, 2010, entitled “CAMERA DEVICE”. The content of which is incorporated by reference herein in its entirety.

### FIELD

Embodiments of the present disclosure relate generally to image pickup devices, and more particularly relate to an image pickup device comprising a plurality of screens thereon.

### BACKGROUND

In conventional camera devices, when an image pickup device faces toward an object, an image of the object captured by the image pickup device is displayed on a display module. A user adjusts the orientation of the image pickup device and a distance to the object while observing the object in front of the image pickup device and the image (through image) displayed on the display module. Then, after placing the object at a desired position within the image at a desired size, the image pickup device performs a shutter operation to capture a still image.

A tablet may be provided on the display module, to aid in specifying a desired region for displaying the through image on the display module. After the through image is displayed on the display module, image processing such as binarization and enlargement are performed exclusively in the desired region of the display module. A through image that has undergone such partial image processing is displayed on the display module.

A user may take a self-portrait by positioning the image pickup device facing toward herself/himself. However, the user may be unable to view the through image on the display module; thereby it is not easy to adjust an orientation of the image pickup device or the distance to the object.

### SUMMARY

A system and method for picking up an image is disclosed. Through images are captured repeatedly until a shutter condition is satisfied, and a face is detected in the through images. It is decided whether the shutter condition is satisfied, if the face is within a face-capture region of at least one of the through images, and an image is captured for recording, if the shutter condition is satisfied. Consequently, still images are easily obtained with a face/object at an intended position and size.

In an embodiment, an image pickup device comprises an image pickup module, a display module, a region-setting module, a face detection module, and a decision module. The image pickup module is operable to repeatedly capture a plurality of through images, and capture an image for recording in response to a satisfied shutter condition signal. The display module comprises a screen and is operable to display the through images, and the region-setting module is operable to set a face-capture region on the screen. The face detection module is operable to detect a face in the through images, and the decision module operable to decide whether a shutter condition is satisfied, and signal the satisfied shutter condition signal, if the face is within the face-capture region.

In another embodiment, a method for picking up an image captures through images repeatedly until a shutter condition is satisfied. An object is detected in the through images, and it is decided whether the shutter condition is satisfied, if the object is within a face-capture region of at least one of the through images. An image for recording is captured, if the shutter condition is satisfied.

In yet another embodiment, a computer-readable medium for capturing an image for recording comprises program code that captures through images repeatedly until shutter condition is satisfied. The program code further detects a face in the through images, and decides whether the shutter condition is satisfied, if the face is within a face-capture region on the through images. The program code further captures an image for recording, if the shutter condition is satisfied.

In yet another embodiment, an image pickup device comprises an image pickup module, a display module, and a memory module. The image pickup module is operable to capture through images and a still image, and the display module comprises a screen and is operable to display the captured through images repeatedly on the screen. The memory module is operable to store the still image, if a face of a person to be captured is inside a face-capture region on the screen.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure.

FIG. 1 is an illustration of an exemplary functional block diagram of a mobile terminal comprising an image pickup device according to an embodiment of the disclosure.

FIG. 2A is an illustration of a perspective view of an exemplary exterior of an image pickup device showing a first main surface side of a mobile terminal according to an embodiment of the disclosure.

FIG. 2B is an illustration of a perspective view of an exemplary exterior of an image pickup device showing a second main surface side of a mobile terminal according to an embodiment of the disclosure.

FIG. 3A is an illustration of an audio guidance during capture of a self-portrait using an image pickup device according to an embodiment of the disclosure.

FIG. 3B is an illustration of an audio guidance during capture of a self-portrait using an image pickup device according to an embodiment of the disclosure.

FIG. 4A is a diagram illustrating an exemplary set region on a touch panel according to an embodiment of the disclosure.

FIG. 4B is a diagram illustrating an exemplary set region on a touch panel according to an embodiment of the disclosure.

FIG. 5 is a diagram illustrating an exemplary set region on a touch panel according to an embodiment of the disclosure.

FIG. 6 is a diagram illustrating an exemplary set region on a touch panel according to an embodiment of the disclosure.

FIG. 7A is an illustration of an audio guidance during capture of a self-portrait using an image pickup device according to an embodiment of the disclosure.

FIG. 7B is an illustration of an audio guidance during capture of a self-portrait using an image pickup device according to an embodiment of the disclosure.

FIG. 8A is an illustration of an audio guidance during capture of a self-portrait using an image pickup device according to an embodiment of the disclosure.

FIG. 8B is an illustration of audio guidance during capture of a self-portrait using an image pickup device according to an embodiment of the disclosure.

FIG. 9A is an illustration of an audio guidance during capture of a self-portrait using an image pickup device according to an embodiment of the disclosure.

FIG. 9B is an illustration of an audio guidance during capture of a self-portrait using an image pickup device according to an embodiment of the disclosure.

FIG. 10 is an illustration of a memory map showing a content of a main memory according to an embodiment of the disclosure.

FIGS. 11 is a flowchart illustrating an exemplary image capture process according to an embodiment of the disclosure.

FIGS. 12 is a flowchart illustrating an exemplary image capture process according to an embodiment of the disclosure.

FIGS. 13 is a flowchart illustrating an exemplary image capture process according to an embodiment of the disclosure.

FIGS. 14 is a flowchart illustrating an exemplary image capture process according to an embodiment of the disclosure.

FIG. 15A is a diagram illustrating an exemplary display screen according to an embodiment of the disclosure.

FIG. 15B is a diagram illustrating an exemplary display screen according to an embodiment of the disclosure.

FIG. 16A is a diagram illustrating an exemplary display screen according to an embodiment of the disclosure.

FIG. 16B is a diagram illustrating an exemplary display screen according to an embodiment of the disclosure.

FIG. 17 is a diagram illustrating variables to decide whether a face is inside a set region according to an embodiment of the disclosure.

FIGS. 18A is an illustration of an audio guidance during capture of a self-portrait using an image pickup device according to an embodiment of the disclosure.

FIGS. 18B is an illustration of an audio guidance during capture of a self-portrait using an image pickup device according to an embodiment of the disclosure.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

Embodiments of the disclosure are described herein in the context of one practical non-limiting application, namely, an information-processing device such as a mobile phone. Embodiments of the disclosure, however, are not limited to such mobile phone, and the techniques described herein may be utilized in other applications. For example, embodiments may be applicable to digital books, digital cameras, electronic game machines, digital music players, personal digital assistance (PDA), personal handy phone system (PHS), laptop computers, mobile TV's, health equipment, medical equipment, display monitors, and the like.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

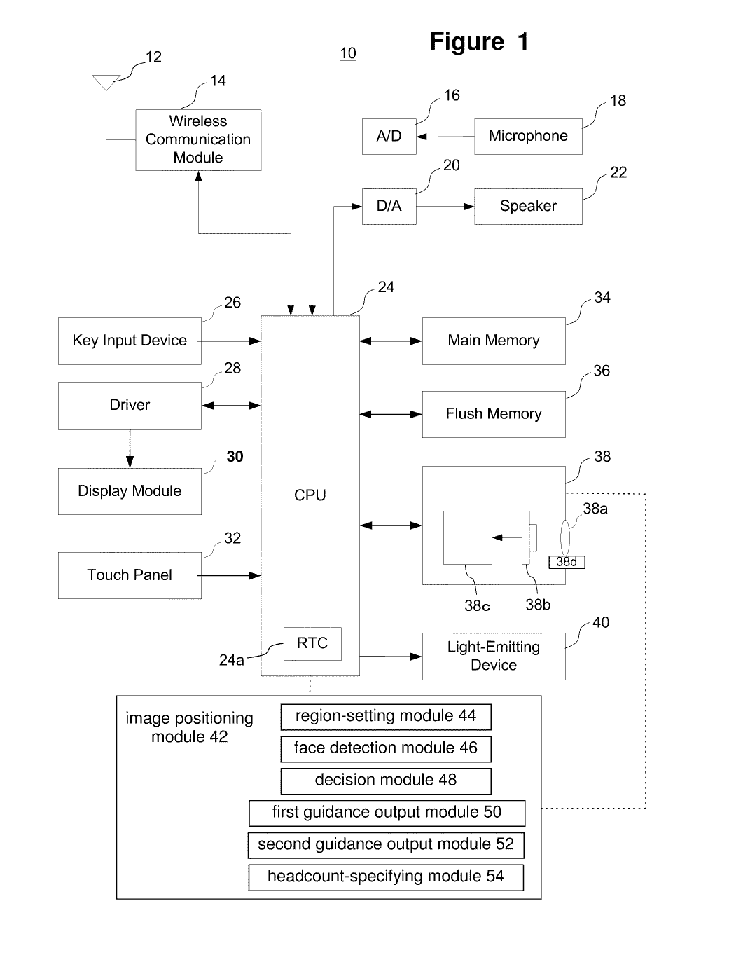

FIG. 1 is an illustration of an exemplary functional block diagram of a mobile terminal 10 (system 10) comprising an image pickup module 38 according to an embodiment of the disclosure. The mobile terminal 10 comprises a CPU 24, a key input device 26, a touch panel 32, a main memory 34, a flash memory 36, the image pickup module 38, a light-emitting device 40, a wireless communication module 14, a microphone 18, an A/D converter 16, a speaker 22, a D/A converter 20, and a display module 30.

The system 10 may also comprise an image positioning module 42 operable to position images at an intended position and size. The image positioning module 42 may reside on the CPU 24 and/or on the image pickup module 38. Alternatively, the image positioning module 42 may be coupled externally to the CPU 24 and/or to the image pickup module 38.

A practical system 10 may comprise any number of input modules, any number of processor modules, CPUs, any number of memory modules, and any number of display modules. The illustrated system 10 depicts a simple embodiment for ease of description. These and other elements of the system 10 are interconnected together, allowing communication between the various elements of system 10. In one embodiment, these and other elements of the system 10 may be interconnected together via a communication link (not shown).

Those of skill in the art will understand that the various illustrative blocks, modules, circuits, and processing logic described in connection with the embodiments disclosed herein may be implemented in hardware, computer-readable software, firmware, or any practical combination thereof. To illustrate clearly this interchangeability and compatibility of hardware, firmware, and software, various illustrative components, blocks, modules, circuits, and steps are described generally in terms of their functionality.

Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as causing a departure from the scope of the present disclosure

The CPU 24 is electrically coupled to the key input device 26, the touch panel 32, the main memory 34, the flash memory 36, the image pickup module 38, and the light-emitting device 40. Furthermore, the CPU 24 is electrically coupled to an antenna 12 via the wireless communication module 14, the microphone 18 via the A/D converter 16, the speaker 22 via the D/A converter 20, and the display module 30 via a driver 28. The CPU 24 comprises a Real Time Clock (RTC) 24a.

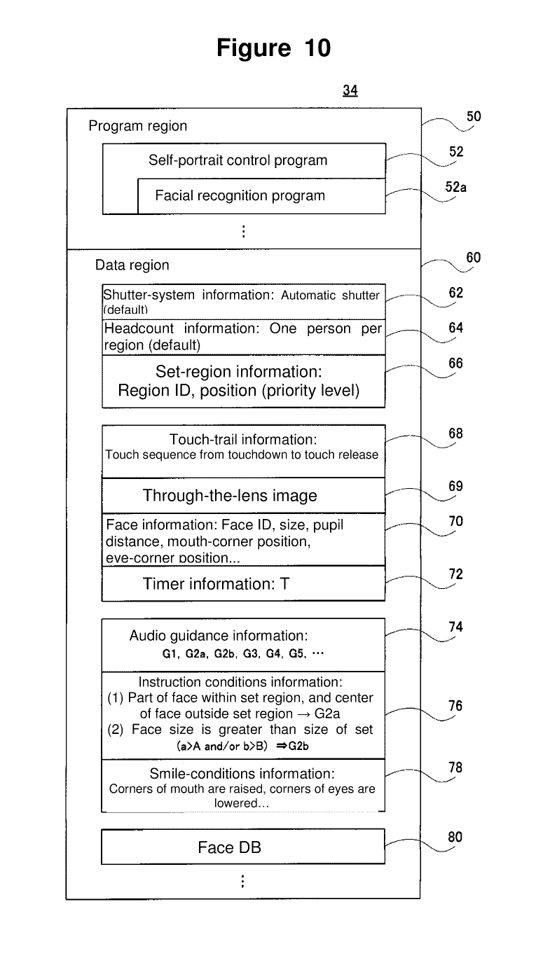

The CPU 24 is configured to support functions of the system 10. The CPU 24 may control operations of the system 10 so that processes of the system 10 are suitably performed. For example, the CPU 24 executes various processes in accordance with programs stored in the main memory 34. Timing signals necessary for executing such processes are provided from an RTC 24a. The CPU 24 accesses the main memory 34 to access programs and data as explained in more detail in the context of discussion of FIG. 10 below. The CPU 24 also controls the display module 30, and the image pickup module 38 to display input/output parameters, images, notifications, and the like.

The CPU 24, may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

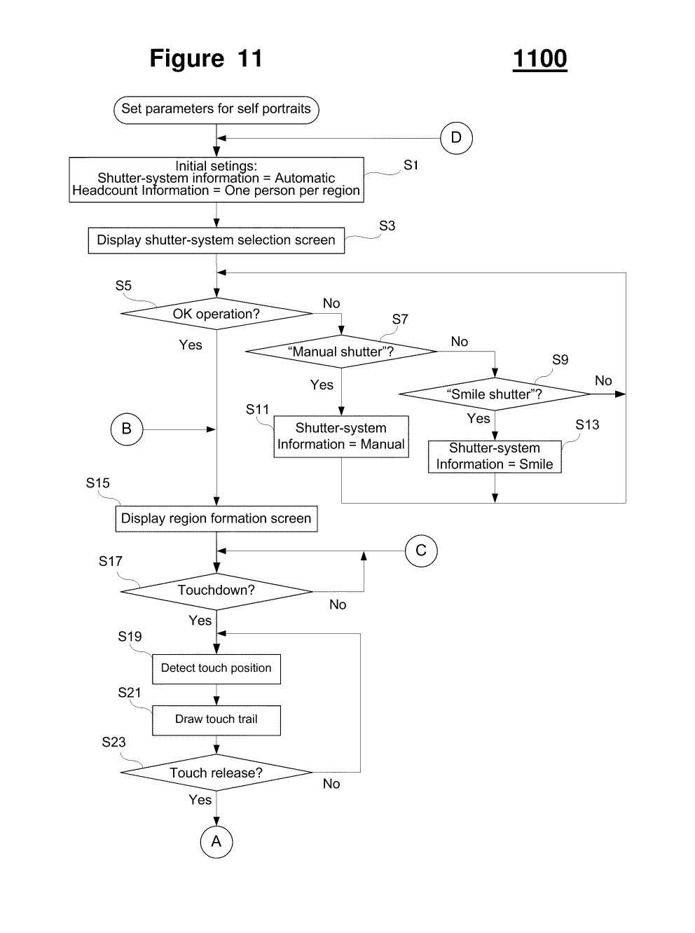

In practice, the CPU 24 comprises processing logic that is configured to carry out the functions, techniques, and processing tasks associated with the operation of system 10. In particular, the processing logic is configured to support operation of the system 10 such that still images are easily obtained with an object such as face at an intended position and size. Operations of the CPU 24 are explained in more detail in the context of discussion of FIGS. 11 through 14.

The antenna 12 receives radio signals from a base station (not shown), and sends radio signals from the wireless communication module 14.

The wireless communication module 14 demodulates and decodes the radio signals received by the antenna 12, and encodes and modulates signals from the CPU 24.

The microphone 18 converts sound waves into analog audio signals, and the A/D converter 16 converts the audio signals from the microphone 18 into digital audio data.

The D/A converter 20 converts the audio data from the CPU 24 into analog audio signals, and the speaker 22 converts the audio signals from the D/A converter 20 into sound waves.

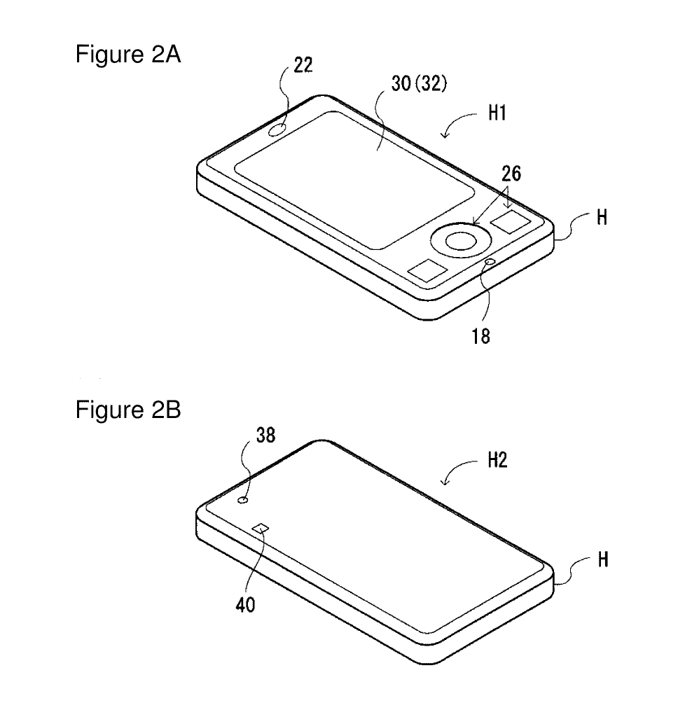

The key input device 26 may comprise various keys, buttons and a trackball (see FIG. 2A), and the like. The key input device 26 is operated by the user, and sends signals (commands) corresponding to operations to the CPU 24.

The driver 28 displays images corresponding to the signals received from the CPU 24 on the display module 30.

The display module 30 is operable to display the through images captured by the image pickup module 38. The display module 30 comprises a screen comprising the touch panel 32 on the surface thereof. The touch panel 32 sends signals, such as but without limitation, coordinates indicating a position of a touched point, and the like, to the CPU 24. The display module 30 is configured to display various kinds of information via an image/video signal supplied from the CPU 24.

The display module 30 may accept a user input operation to input and transmit data, and input operation commands for functions provided in the system 10. The display module 30 accepts the operation command, and outputs operation command information to the CPU 24 in response to the accepted operation command as explained in more detail below. The display module 30 may be formed by, for example but without limitation, an organic electro-luminescence (OEL) panel, liquid crystal panel (LCD), and the like.

The main memory 34 may comprise a data storage area with memory formatted to support the operation of the system 100. In addition to storing programs and data for executing various processes in the CPU 24, the main memory 34 provides necessary work areas for the CPU 24 as explained in more detail in the context of discussion of FIG. 10 below. The main memory 34 may be any suitable data storage area with suitable amount of memory that is formatted to support the operation of the system 10. The main memory 34 is configured to store, maintain, and provide data as needed to support the functionality of the system 10 in the manner described below.

In practical embodiments, the main memory 34 may comprise, for example but without limitation, a non-volatile storage device (non-volatile semiconductor memory, hard disk device, optical disk device, and the like), a random access storage device (for example, SRAM, DRAM, SDRAM), or any other form of storage medium known in the art. The main memory 34 may be coupled to the CPU 24 and configured to store, for example but without limitation, the input parameter values and the output parameter values corresponding to the a risk assessment scenario.

Additionally, the main memory 34 may represent a dynamically updating database containing a table for purpose of computing using the CPU 24. The main memory 34 may also store, a computer program that is executed by the CPU 24, an operating system, an application program, tentative data used in executing a program processing, and the like, as shown in FIG. 10 below. Further, the main memory 34 stores the still image, if a test condition is true. The test condition may comprise: a shutter is pressed, the face remains in the face-capture region for a predefined time, and the face inside the face-capture region comprises a smiling face as explained in more detail below.

The main memory 34 may be coupled to the CPU 24 such that the CPU 24 can read information from and write information to memory module 612. As an example, the CPU 24 and the main memory 34 may reside in their respective ASICs. The main memory 34 may also be integrated into the CPU 24. In an embodiment, the main memory 34 may comprise a cache memory for storing temporary variables or other intermediate information during execution of instructions to be executed by the CPU 24.

The flash memory 36 may include a NAND flash memory and the like. The flash memory 36 may provide a storage space for programs and data as well as a storage space for image data from the image pickup module 38.

The image pickup module 38 is operable to repeatedly capture a plurality of through images, and capture an image for recording in response to a satisfied shutter condition signal as explained in more detail below. The image pickup module 38 may comprise a lens 38a, an image sensor (imaging element) 38b, a camera processing circuit 38c, and a lens-driving driver 38d. The image pickup module 38 can perform photoelectric conversion of an optical image formed by the image sensor 38b through the lens 38a and output corresponding image data. In this manner, the CPU 24 controls operation of the image sensor 38b and the driver 38d to suitably adjust exposure amount and focus of the image data. The image pickup module 38 then outputs the adjusted image data.

The image positioning module 42 is operable to position images at an intended position and size. The image positioning module 42 comprises a region-setting module 44, a face detection module 46, a decision module 48, a first guidance output module 50, a second guidance output module 52, and a headcount-specifying module 54.

The region-setting module 44 is operable to set a face-capture region on the screen of the display module 30. The region-setting module 44 may set the face-capture region via the touch panel 32.

The face detection module 46 is operable to detect faces in the through images captured by the image pickup module 38.

The decision module 48 is operable to decide whether a shutter condition is satisfied, and signal a satisfied shutter condition signal, if the face is within the face-capture region. The image pickup module 38 captures the image for recording by referring to the decision result of the decision module 48.

The first guidance output module 50 is operable to output first guidance information comprising a notification that the face is positioned within the face-capture region, if the face detection module 50 detects a face within the face-capture region. The first guidance information comprises guidance that prompts a shutter operation.

The second guidance output module 52 is operable to output second guidance information for placing the face into the face-capture region, if a face detected by the face detection module is outside the face-capture region.

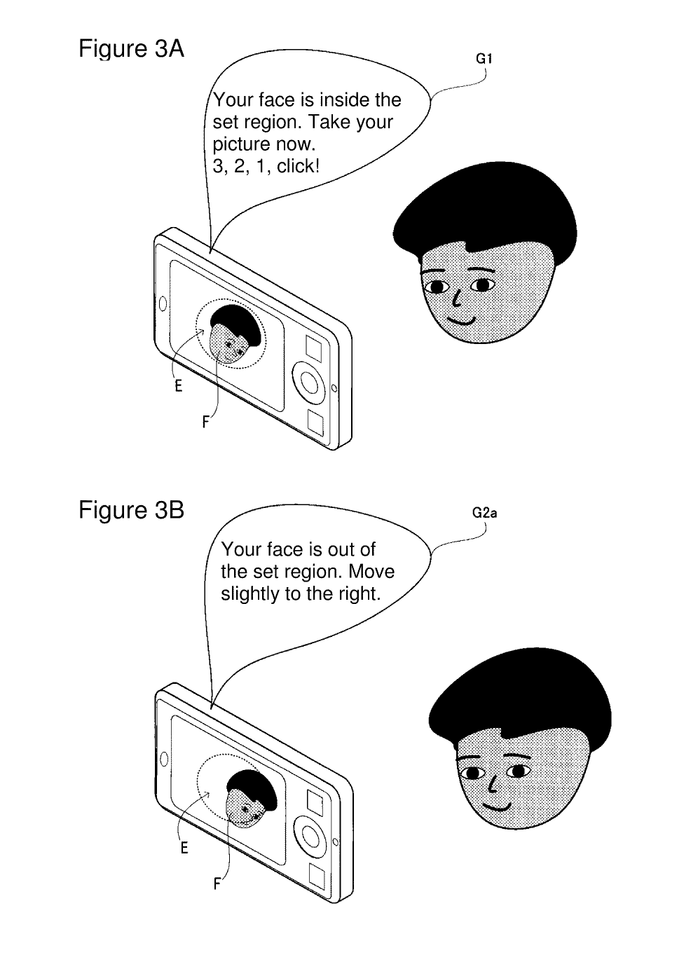

The headcount-specifying module 54 is operable to specify a headcount. The decision module 48 makes a decision whether a number of faces equivalent to the headcount specified by the headcount-specifying module is detected within a set region (FIG. 3A).

The light-emitting device (LED) 40 may comprise a single LED or multiple LEDs and related drivers, and the like. The light-emitting device 40 can emit light corresponding to signals received from the CPU 24.

FIGS. 2A and 2B are illustrations of perspective views of exemplary exteriors of a first main surface side and a second main surface side of the mobile terminal 10 respectively. The mobile terminal 10 comprises a housing H that can suitably house items described above in the context of discussion of FIG. 1. The housing H may comprise the microphone 18, the speaker 22, the key input device 26, the display module 30 and the touch panel 32 on one main surface side such as the first main surface H1, and may comprise the image pickup module 38 and the light-emitting device 40 on the other main surface side such as the second main surface H2.

In one embodiment, the image pickup module 38 is provided on the first main surface H1 of the housing H, and the display module 30 is provided on the second main surface H2 that faces the first main surface H1. Depending on the shape of the housing H, the image pickup module 38 and the display module 30 may be provided on mutually perpendicular surfaces (e.g., one on the main surface and one on a lateral surface). In other words, although it is preferable that they are provided on different surfaces (as this makes the effects described below more prominent), they may be provided on the same surface

By using a menu screen (not shown), it is possible to select various modes in the mobile terminal 10. The modes may comprise, for example but without limitation, a call mode for making telephone calls, a normal image capture mode for performing normal image capture, and a self-portrait mode for taking self-portraits, and the like.

If the call mode is selected, the mobile terminal 10 functions as a calling device. Specifically, when a call-request operation is performed using the key input device 26 or the touch panel 32, the CPU 24 instructs the wireless communication module 14 to output a call-request signal. The output call-request signal is transmitted from the antenna 12 to an antenna of a callee's phone device (receiver) through a mobile communications network (not shown). The callee's phone device may indicate reception of a call through a ringtone, and the like. When the receiver performs a call-acceptance operation, the CPU 24 starts a call processing.

On the other hand, when the antenna 12 receives a call-request signal from a caller, the wireless communication module 14 notifies the CPU 24 of the received call, and the CPU 24 notifies reception of a call through, for example, a ringtone. When a call-acceptance operation is performed using the key input device 26 or the touch panel 32, the CPU 24 starts a call processing.

The call processing is performed as described below. The antenna 12 receives audio signals sent from the caller and the wireless communication module 14 performs demodulation and decoding on the received audio signals. Subsequently, the demodulated and decoded received audio signals are transmitted to the speaker 22 via the D/A converter 20, and the speaker 22 outputs the demodulated and decoded received audio signals.

On the other hand, audio signals received by the microphone 18 are encoded and modulated by the wireless communication module 14, and then sent to the receiver at the callee's phone via the antenna 12. The transmitted modulated and decoded audio signals are then demodulated and decoded at the receiver of the callee's phone via a D/A converter such as the D/A converter 20. A speaker such as the speaker 22 then outputs the demodulated and decoded received audio signals at the speaker of the callee's phone.

If the normal image capture mode is selected, the mobile terminal 10 functions as a camera device or an image pickup device for normal image capture. In this manner, the CPU 24 issues an instruction to start through image capture, and the image pickup module 38 starts through image capture.

In the image pickup module 38, light passes through the lens 38a and an optical image formed by the image sensor 38b is subject to photoelectric conversion, and as a result, a charge representing to the optical image is generated.

In through image capture, a part of the charge generated by the image sensor 38b is read out as a low-resolution image signal about every 1/60 second, for example. The read-out raw image signals are subjected to series of image processing such as A/D conversion, color separation, and YUV conversion and the like by the camera processing circuit 38c, and are thus converted into YUV-format image data.

Thus, low-resolution image data for through display are output from the image pickup module 38 at a frame rate of 60 fps. The output image data are written into the main memory 34 as the current through image data 69 (FIG. 10), and the driver 28 repeatedly reads the through image data stored in the main memory 34 to display a through image based thereon on the display module 30.

A user may hold the mobile terminal 10 in his/her hand or place it on a table, and may face the image pickup module 38 toward an object. The display module 30 displays a through image captured by the image pickup module 38. The user can adjust an orientation of the image pickup module 38 and a distance to the object while referring to the display module 30 to capture the object in a desired position. When adjustments are completed, a shutter operation may be performed using the key input device 26.

The CPU 24 issues an instruction to capture a still image in response to the shutter operation. In response, the image pickup module 38 executes a still-image capture. In the image pickup module 38, an optical image formed on the light-receiving surface of the image sensor 38b via the lens 38a is subject to photoelectric conversion. As a result, a charge representing the optical image is generated. In still-image capture, the charge generated in the image sensor 38b in this manner is read out as a high-resolution raw image signal. The read-out raw image signals are subjected to a series of image processes such as A/D conversion, color separation, and YUC conversion and the like by the camera processing circuit 38c, and are thus converted into YUV-format image data.

In this manner, high-resolution image data for recording are output from the image pickup module 38. The output image data are temporarily retained in the main memory 34. The CPU 24 writes the image data that have been temporarily retained in the main memory 34 as still-image data into the flash memory 36.

FIGS. 3A and 3B are illustrations of exemplary audio guidance during capture of a self-portrait using an image pickup device according to an embodiment of the disclosure. If the self-portrait mode is selected, the mobile terminal 10 functions as a camera device for self-portraits. The user may hold the mobile terminal 10 in their hand or place the mobile terminal 10 on a table, and may face the image pickup module 38 toward his/her own face. A through image captured by the image pickup module 38 is displayed on the display module 30. However, since the display module 30 is on a surface opposite to the image pickup module 38, the user may be unable to adjust the orientation of the image pickup module 38 or the distance to the user's own face, while viewing the through image.

By selecting the self-portrait mode and preliminarily setting a desired set region E (face-capture region) on a display surface of the display module 30, when a face F enters the set region E, a notification indicating relative position of the users face to the set region E is output from the speaker 22 as shown in a callout G1 in FIG. 3A. In one embodiment, the notification may be performed via the light-emitting device 40 and/or the speaker 22, a vibration through a vibrator, a combination thereof, and the like.

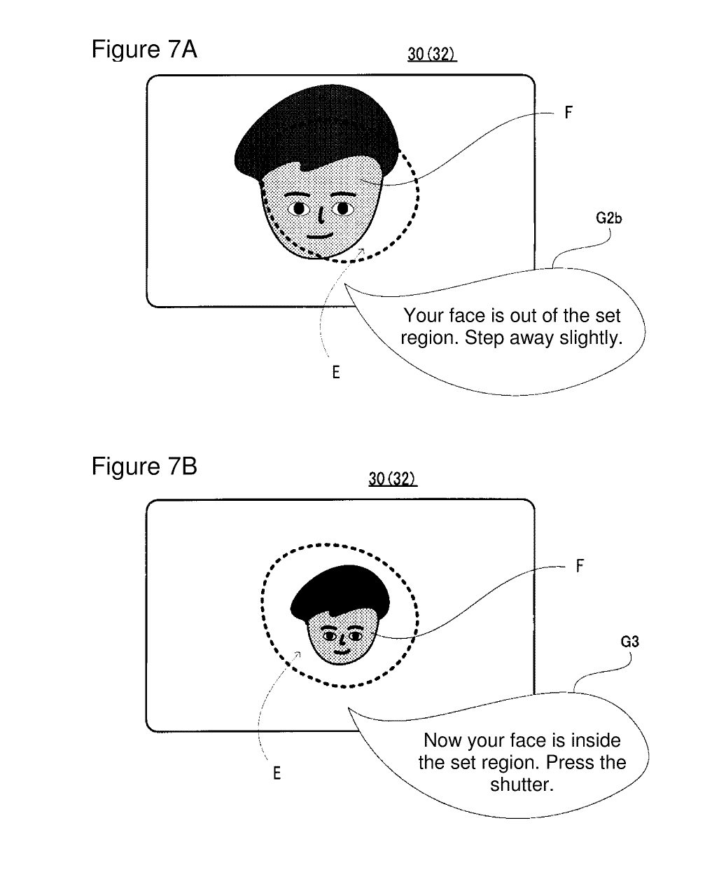

A guidance may be output from the speaker 22 based on a relative position between the face F and the set region E. For example, if the face F is protruding from the set region E as shown in FIG. 3B and FIG. 7A, guidance for placing the face F within the set region E such as “Your face is out of the set region. Move slightly to the right” as shown in a callout G2a, or “Your face is protruding from the set region; please step away slightly” as shown in a callout G2b is output from the speaker 22. Therefore, the user can adjust the orientation of the image pickup module 38 or the distance from his/her or a face by relying on audio from the speaker 22 and/or by light emitting from the light-emitting device 40 even if the user cannot see the image on the display module 30.

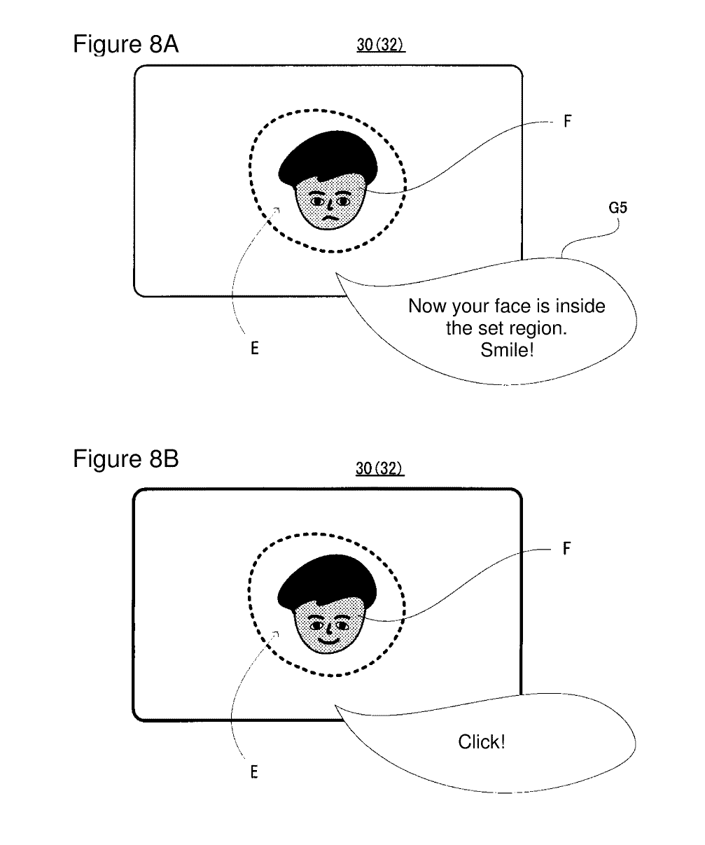

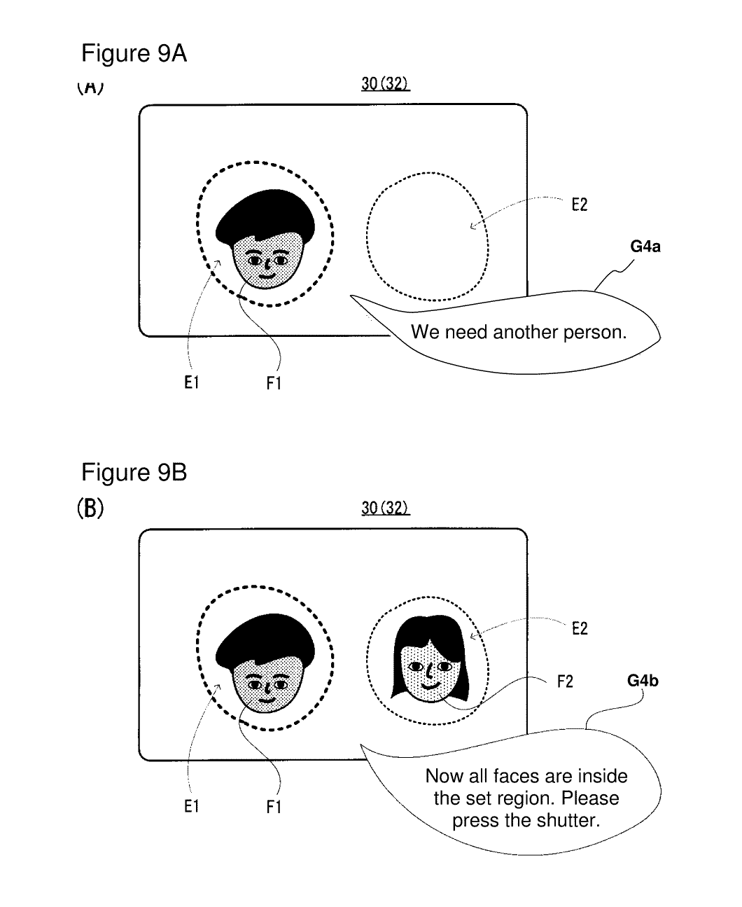

When the face F is within the set region E, still-image capture is executed automatically (see FIG. 3A: automatic shutter system), in response to a shutter operation by the user (see FIGS. 7B and 9B: manual shutter system), or in response to the detection of a smiling face of the user (see FIG. 8B: smile shutter system). Accordingly, the user is able to capture his/her own face in a desired composition.

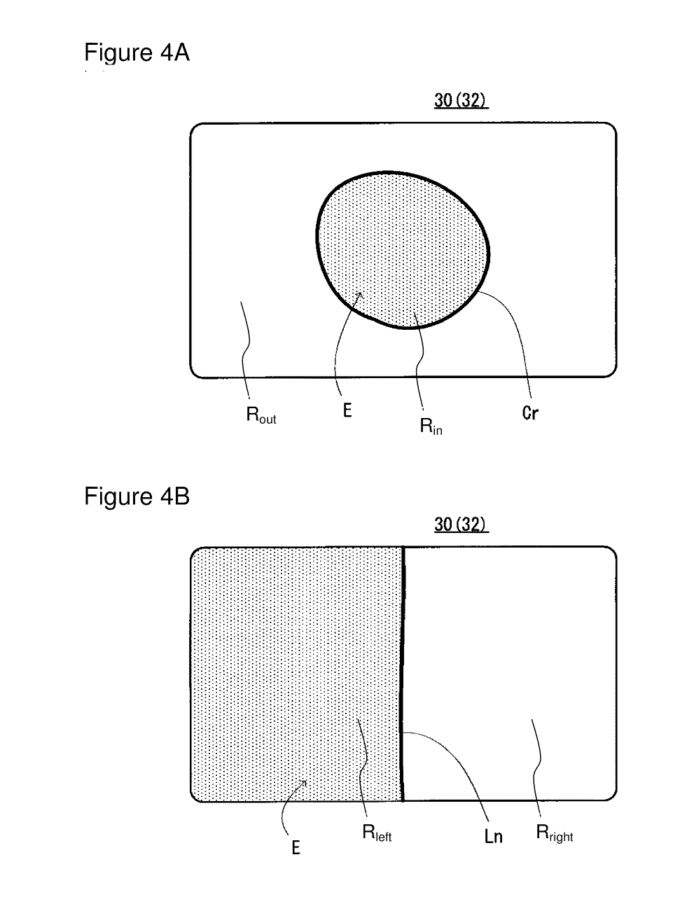

FIGS. 4A and 4B are illustration of exemplary set regions on a touch panel 32 according to embodiments of the disclosure. Before taking a self-portrait, a user can set an arbitrary (or desired region) region E by using the display module 30 and the touch panel 32. When a user draws an appropriately sized circle on the screen of the display module 30, for example, a trail is detected by the touch panel 32, and a circle Cr representing the detected trail is drawn on the screen of the touch panel 32 as shown in FIG. 4A. The screen is divided into an inside area Rᵢₙ and outside area Rₒᵤₜ of the circle Cr. The user can set the inside area Rᵢₙ to the region E by touching the inside area Rᵢₙ. Instead of a circle, the user may draw a polygon such as a square or a pentagon and the like, and may also draw complex shapes such as an hourglass shape or a keyhole shape. Essentially, any shape may be drawn as long as it forms a closed region within the screen.

Alternatively, as shown in FIG. 4B, when the user draws an appropriate vertical line from the approximate midpoint of the top edge to the approximate midpoint of the bottom edge on the screen of the touch panel 32 (screen of the display module 30) the trail is detected by the touch panel 32, and a line Ln indicating the detected trail is drawn on the screen. As a result, the screen is divided into the left area R_{left} and right area R_{right} of the line Ln. If the user touches the left area R_{left}, the left area R_{left} is set as the region E. A user may draw a horizontal line from the left side of the screen to the right side of the screen, or an L-shaped line from the top side of the screen to the right side of the screen. Essentially, any line may be drawn as long as it divides the screen into two (or more) regions. A user can also set multiple set regions E as explained in more detail below.

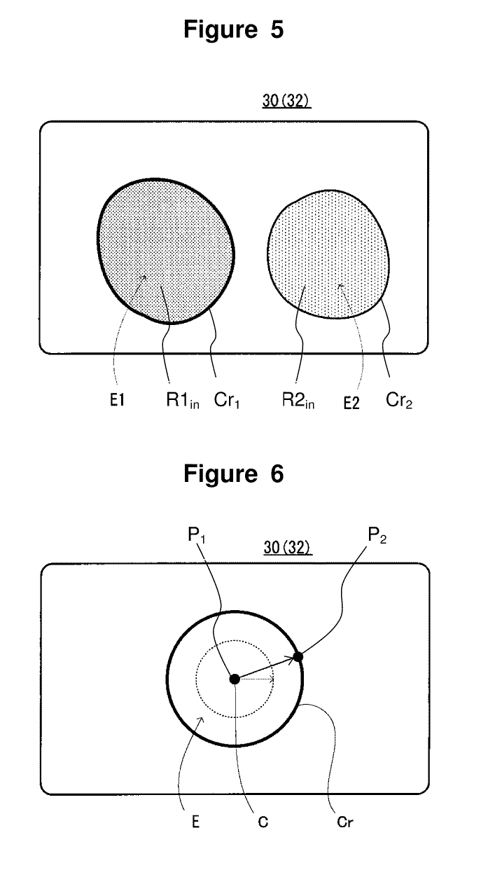

FIG. 5A and 5B are illustration of exemplary set regions on the touch panel 32 according to embodiments of the disclosure. For example, the user can draw two circles Cr1 and Cr2, and touches the inside areas of the circles Cr1 and Cr2. As a result, the inside areas of the two circles Cr1 and Cr2 are set as the regions E1 and E2, respectively. In this manner, a touching order to the regions E1 and E2 is stored as priority information of the regions E1 and E2. The CPU 24 may refer the priority information during an AF/AE process or a face detection process. The priority information may be used in the following manner. A user may draw a circle in other ways as explained in more detail in the context of discussion of FIG. 6 below.

In the AF/AE process, when calculating an optimal focus position and optimal exposure amount, there is a method of weighting each region E1, E2 . . . according to the priority information. Instead of performing face detection evenly throughout the entire screen, face detection may be performed on a priority basis in each region. If a smile-shutter system is selected, smile judgment may be performed on a priority basis in each region.

Brightness and the like can be changed in only the set region E or each region E1, E2, . . . during image processing.

FIG. 6 is an illustration of an exemplary setting region on the touch panel 32. Instead of drawing an arbitrarily sized circle as in FIG. 4A, the user may first touch a desired point P1 with a fingertip on the screen to specify the center C of the circle, and then sideslip (slide) the fingertip (touch point) to a point P2 with maintaining the fingertip on the screen in order to decide the radius of the circle. When the CPU 24 detects a touchdown on the touch panel 32, the CPU 24 sets the touchdown point as the center C of the circle, and when the touch point is continuously sliding on the screen, the CPU 24 is continuously displaying a circle with a different diameter.

That is, a circle passing through the current touch point and a circle Cr that expands and contracts in response to the movement of the touch point is displayed. When the CPU 24 detects a touch release, the CPU 24 sets the inside area of the circle Cr drawn at that moment as the region E. In an embodiment, the display module 30 may draw a circle shown in a dotted line (FIG. 6) as a default with detection of a first touch for a center of a circle on the touch panel 32. Then, when the user CPU 24 detects a second touch for a radius, the circle will expand/shrink based on the location of the second touch.

The user can set a set region before taking a self-portrait. In the same manner, the user can also select a shutter system or set an object headcount (the number of faces to be placed in a single region) before taking a self-portrait. The mobile terminal 10 may have three types of shutter systems: “automatic shutter”, “manual shutter” and “smile shutter”. In an embodiment, the default may be “automatic shutter”. Regarding the object headcount, it is possible to set two or more persons in a set region as well as a person in a set region. In an embodiment, a default state is “one person per set region”.

If “automatic shutter” is selected as the shutter system and “one person per region” is selected as the object headcount (i.e., in the default state), when the face F enters the set region E as shown in FIG. 3A, a notification of the information, “Your face is inside the set region”, is output, and subsequently, guidance for informing the user of a timing of the still-image capture (i.e., for allowing the user to prepare by posing, smiling and the like.), “Take your picture: 3, 2, 1, click!”, is continuously output. The still-image capture is automatically executed at the timing of “click!” as shown in call out G1.

If the shutter system is changed to “manual shutter” while keeping the object headcount to “one person per set region”, after the notification of “Your face is inside the set region” is output in response to the entrance of the face F within the set region E, guidance prompting the user to execute a shutter operation, “Press the shutter”, is output as shown in call out G3.

If the shutter system is changed to “smile shutter” while keeping the object headcount to “one person per region”, after a notification of “Your face is inside the set region” is output in response to the entrance of the face F within the set region E as shown in FIG. 8A, guidance prompting the user to smile such as “Smile!” is output as shown in call out G5. After the face F changes to a smiling face, still-image capture is executed as shown in FIG. 8B.

FIGS. 9A and 9B are illustrations of audio guidance during capture of a self-portrait using the image pickup module 38. If two regions E1 and E2 are set while keeping the object headcount to “one person per region” and the shutter system to “manual shutter” (i.e., the default state), when faces F1 and F2 enter the set regions E1 and E2 respectively as shown in FIG. 9B, notification of the information that “Now all faces are inside the set regions” is output, and guidance stating “Please press the shutter” is continuously output as shown in call out G4b.

When a face is inside only one of either the set region E1 or E2, or when the face F1 is within the set region E1 but there is still no face within the set region E2 as shown FIG. 9A, either nothing is output, or guidance prompting entrance of another face such as “We need another person” is output. Instead of such guidance, notification stating “There is still no face within one set region”) may be output as shown in call out G4a.

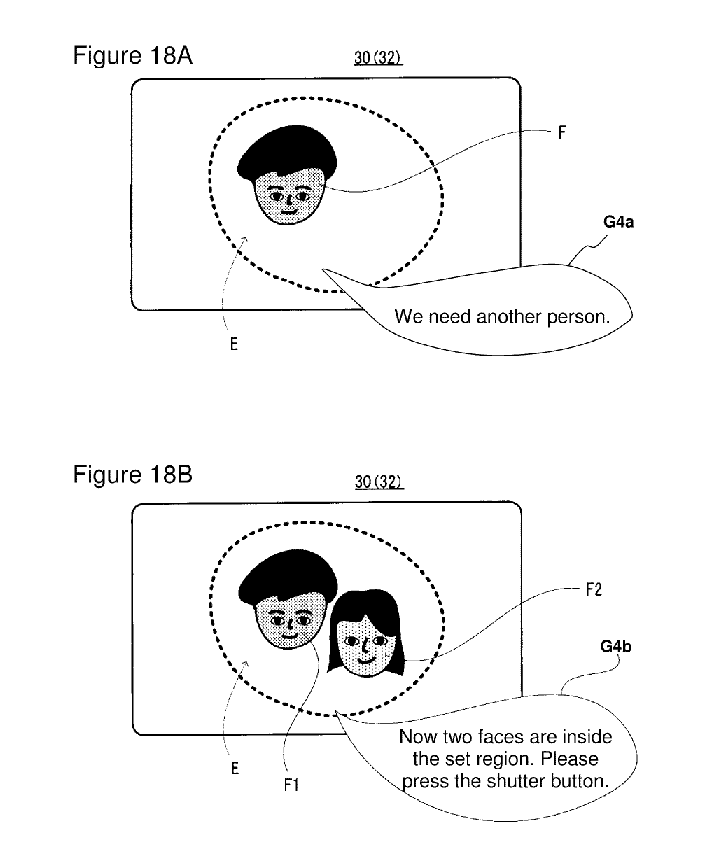

If the object headcount is changed to “two people per region” while keeping the shutter system to “manual shutter”, after two faces F1 and F2 enter the set region E as shown in FIG. 18B, notification of the fact such as “Now two faces are inside the set region” is output, and guidance stating “Please press the shutter” is continuously output as shown in a callout G4b. If only one person is inside the set region E as shown in FIG. 18A, either nothing is output, or guidance prompting the entrance of another face such as “We need another person” is output as shown in a callout G4a. Alternatively, notification stating “There is still only one person within the set region” may be output.

If the object headcount is “two people per region” in “automatic shutter” or “manual shutter”, when two faces F1 and F2 enter the set region E, notification similar to that described above, “Two people are in the set region”, is output (not shown). Generally, when a number of faces F (F1, F2, . . . ) equivalent to the object headcount enter the set region E, notification of the information such as “The set number of people are in the set region now” is output for any shutter system. However, when only a number of faces F (F1, F2, . . . ) that does not meet the object headcount is in the set region E, either nothing is output, or guidance prompting the entrance of more people is output, or notification and the like regarding the headcount currently entered is output.

The CPU 24 can execute the above image pickup processes for “self-portrait” mode and the setting processes for “self-portrait” parameters such as the region E, the shutter system and the object headcount and the like, in accordance with the process shown in FIGS. 11 to 14 based on the programs shown in FIG. 10 and data stored in the main memory 34.

FIG. 10 is an illustration of an exemplary memory map showing the content of the main memory 34 according to an embodiment of the disclosure. The main memory 34 comprises a program region 50 and a data region 60.

The self-portrait control program 52 is stored in the program region 50. The self-portrait control program 52 comprises a facial recognition program 52a. The program region 50 can also store programs such as a communication control program for implementing the call mode described above (or a data communication mode for performing data communication) and a normal-image-capture control program for implementing the normal image capture mode described above (not shown in FIG. 10).

The data region 60 can store shutter-system information 62, headcount information 64, set-region information 66, touch-trail information 68, through image data 69, face information 70, timer information 72, audio-guidance information 74, instruction-conditions information 76, smile-conditions information 78, and a face DB 80.

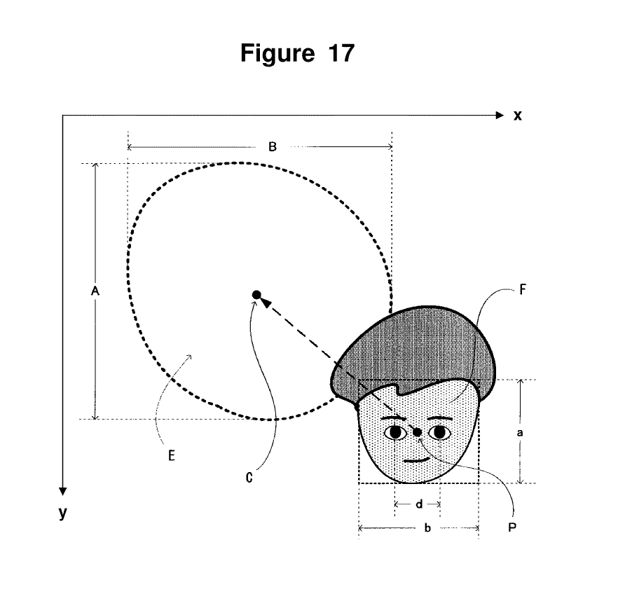

The shutter-system information 62 comprises information indicating the shutter system that is currently selected, and changes between “automatic shutter”, “manual shutter” and “smile shutter” (the default is “automatic shutter”). The headcount information 64 is information indicating the object headcount that is currently set (the default is “one person per region”). The set-region information 66 is related to the region E that is currently set. The set-region information 66 comprises a region ID, position (coordinates of the center C as shown in FIG. 17), and size (height A x width B as shown in FIG. 17) and the like for one set region E or each of multiple set regions E1, E2, . . . .

The touch-trail information 68 comprises information indicating the positions (coordinates) of a series of touch points detected in a period between touchdown and touch release. The through image data 69 are low-resolution image data that are currently displayed on the display module 30, and are updated every frame period ( 1/60 seconds). The face information 70 is information related to the face F that is currently detected, and specifically, it comprises description of a face ID, position (coordinates of the center P as shown in FIG. 17), size (height a×width b as shown in FIG. 17), pupil distance such as d shown in FIG. 17, mouth-corner position (whether the corners of the mouth are raised relative to the rest of the lips), and eye-corner position (whether the corners of the eyes are lowered relative to the rest of the eyes) and the like for one face F or each of multiple faces F1, F2, . . . .

The timer information 72 indicates the duration (T) of a state (detected state) in which a number of faces F (F1, F2, . . . ) equivalent to the set headcount is detected within the set region E. Specifically, the timer information 72 shows “0” as an undetected state if the number of faces F (F1, F2, . . . ) equivalent to the set headcount has not yet been detected within the set region E (undetected state). If the undetected state shifts to a detected state in which one or more faces are detected, a count-up is started, and then the count increases per one frame in the detected state. The timer information 72 is reset to “0” if the detected state shifts to the undetected state.

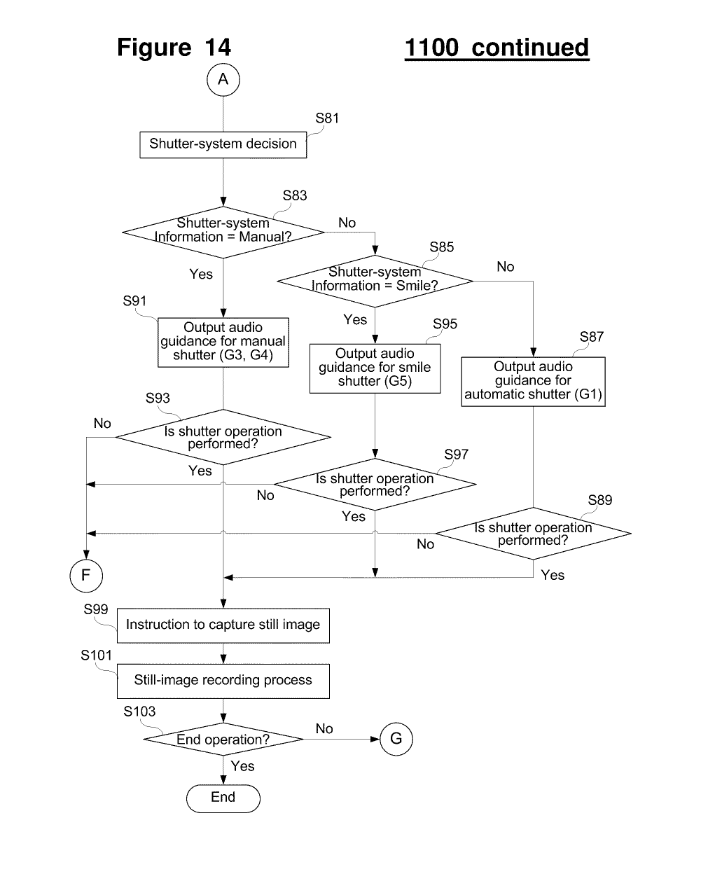

The audio-guidance information 74 comprises information for outputting audio guidance G1 and G3 to G5 in FIG. 14, and instructive audio guidance G2a and G2b for the various shutters described above from the speaker 22.

The instruction-conditions information 76 comprises information indicating conditions for executing instructions for placing the face F within the set region E, and comprises at least two types of information: instruction conditions 1 and 2. The instruction conditions 1 and 2 are defined as follows using variables shown in FIG. 17.

The instruction condition 1 states that “Module of the face F is within the set region E, and the center P of the face F is outside the set region E”, and when this condition is satisfied, the vector PC for moving the center P of the face F to the center C or the set region E is calculated, and the instructive audio guidance G2a comprising directional information (e.g., “To the right”) based on this calculated result is output (FIG. 3B).

On the other hand, the instruction condition 2 states that “The size of the face F is greater than the size of the set region E” (a>A and/or b>B), and when this condition is satisfied, the instructive audio guidance G2b is output (refer FIG. 7A).

The smile-conditions information 78 comprises information indicating conditions for judging that the face F shows the characteristics of a smiling face, and describes changes unique to a smiling face, such as “The corners of the mouth are raised” and “The corners of the eyes are lowered”. The face DB 80 is a database describing the characteristics of human faces (the contour shape of the skin-color region, and the positions of multiple characteristic points such as the center of the pupils, the inner corners of the eyes, the corners of the eyes, the center of the mouth, and the corners of the mouth) and the characteristics of a smiling face (positional changes in specific characteristic points such as the corners of the mouth and the corners of the eyes), and is generated by preliminarily measuring the faces of multiple people.

FIGS. 11 through 14 are illustration of flowcharts showing exemplary process 1100 that can be performed by the system 10. The various tasks performed in connection with process 1100 may be performed, by software, hardware, firmware, a computer-readable medium having computer executable instructions for performing the process method, or any combination thereof. The process 1100 may be recorded in a computer-readable medium such as a semiconductor memory, a magnetic disk, an optical disk, and the like, and can be accessed and executed, for example, by a computer CPU such as the CPU 24 in which the computer-readable medium is stored.

It should be appreciated that process 1100 may comprise any number of additional or alternative tasks, the tasks shown in FIGS. 11-14 need not be performed in the illustrated order, and process 1100 may be incorporated into a more comprehensive procedure or process having additional functionality not described in detail herein.

For illustrative purposes, the following description of process 1100 may refer to elements mentioned above in connection with FIGS. 1-10. In practical embodiments, portions of the process 1100 may be performed by different elements of the system 10 such as: the CPU 24, the key input device 26, the touch panel 32, the main memory 34, the flash memory 36, the image pickup module 38, the light-emitting device 40, the wireless communication module 14, the microphone 18, the A/D converter 16, the speaker 22, the D/A converter 20, the display module 30, the image positioning module 42, etc. Process 1100 may have functions, material, and structures that are similar to the embodiments shown in FIGS. 1-10. Therefore common features, functions, and elements may not be redundantly described here.

The face detection module 46 comprises, the self-portrait control program 52 that controls various function of the system 10 via the CPU 24, and is a main software program for executing processes in accordance with the process 1100. The facial recognition program 52a is a secondary software program that is used by the self-portrait control program 52 during the execution of such processes. The facial recognition program 52a can recognize faces of people such as the user by implementing a facial recognition process based on the face DB 80 stored in the data region in relation to the image data input via the image pickup module 38, and can also detect the characteristics of smiling faces. The results of this recognition or detection are written into the data region 60 as face information 70 as described below.

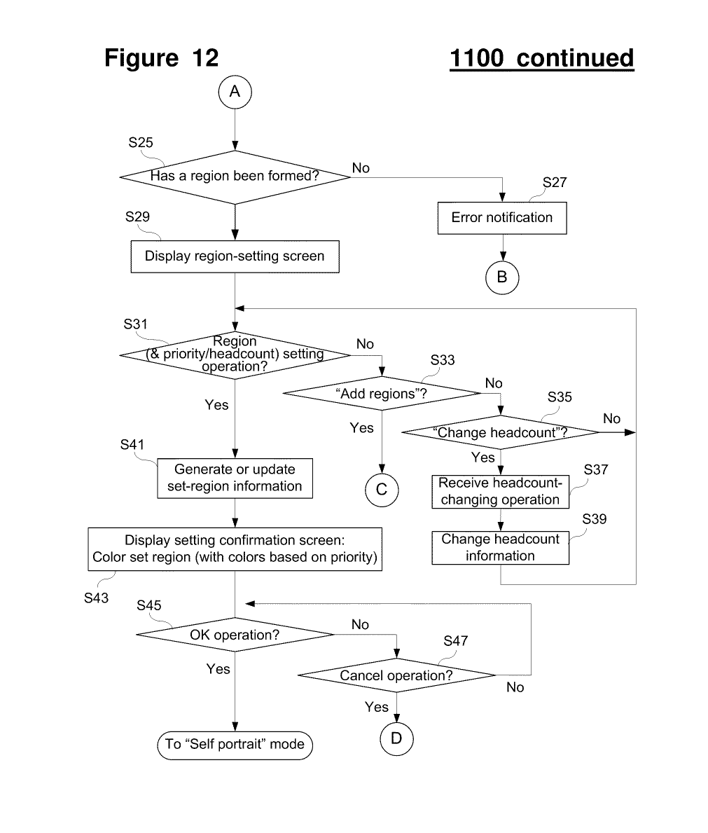

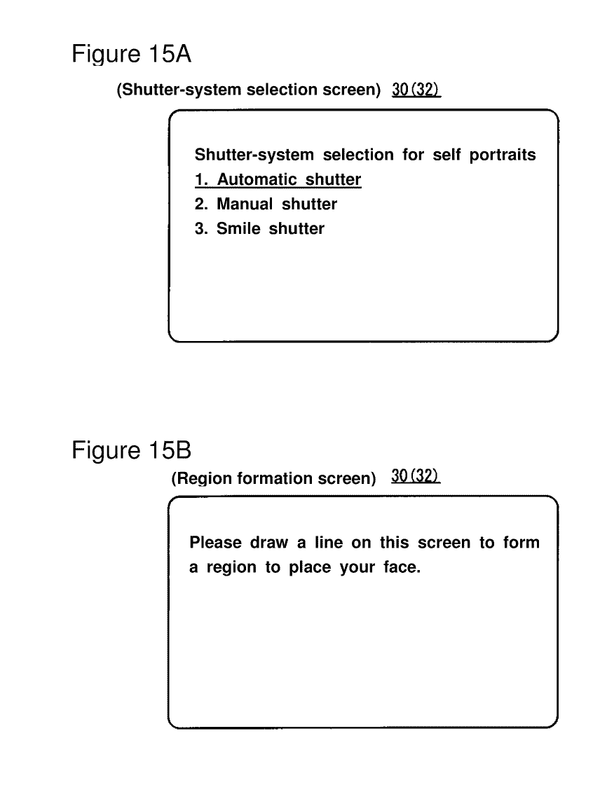

If the “Self-portrait” mode is selected through the menu screen and the like, the CPU 24 first executes a parameter-setting process for self-portraits as shown in FIGS. 11 and 12. In this manner, the CPU 24 initially sets the parameters in task S1. During the initial setting, “Automatic shutter” and “One person” are written in respectively as the initial values for the shutter-system information 62 and the headcount information 64. In task S3, an instruction is issued to the driver 28 and the shutter-system selection screen is displayed on the display module 30 as shown in FIG. 15A. On the shutter-system selection screen, the options of “Automatic shutter”, “Manual shutter” and “Smile shutter” are shown, and “Automatic shutter”, which is the currently selected shutter system, is emphasized by the cursor. The user is able to select an arbitrary shutter system through cursor operations using the key input device 26.

The CPU 24 waits for a key input from the key input device 26 in an inquiry tasks S5, S7 and S9. In response to the key input, CPU 24 decides whether an OK operation has been performed in the inquiry task S5, whether a cursor operation selecting “Manual shutter” has been performed in the inquiry task S7, and whether a cursor operation selecting “Smile shutter” has been performed in the inquiry task S9. If the response is “YES” in the inquiry task S7, after changing the shutter-system information 62 to “Manual shutter” in task S11, the process returns to inquiry task S5. If the response is “YES” in inquiry task S9, after changing the shutter-system information 62 to “Smile shutter” in task S13, the process returns to inquiry task S5. If the response is “YES” in inquiry task S5, the process proceeds to task S15.

In task S15, an instruction is used to the driver 28, and a region formation screen is displayed on the display module 30 as shown in FIG. 15B. On this region formation screen, a message for prompting region formation (“Please draw a line on this screen to form a region to place your face”) is shown. The user is able to set an arbitrary region E within this region formation screen through touch operations on the touch panel 32. Then, the process proceeds to inquiry task S17.

In the inquiry task S17, a judgment is made by the CPU 24 as to whether a touch is performed based on signals from the touch panel 32. If the judgment result changes from “NO” to “YES”, in task S19, the current touch position is detected based on signals from the touch panel 32, and in task S21, an instruction is issued to the driver 28 to show a touch trail on the region formation screen based on the detection results from task S19. In inquiry task S23, a judgment is made by the CPU 24 as to whether a touch release has is performed based on signals from the touch panel 32, and if the response is “NO”, the process returns to task S19 and the same process is repeated for each frame.

When a touch release is detected, the process 1100 proceeds from the inquiry task S23 to inquiry task S25. In the inquiry task S25, a judgment is made by the CPU 24 as to whether the region E has been formed within the screen based on the touch-trail information 68. If the response is “NO”, after performing an error notification in task S27, the process returns to task S15 and repeats the same process. If the response is “YES” in S25, the process proceeds to task S29, and an instruction is issued to the driver 28 to display a region-setting screen on the display module 30. On this region-setting screen, a message prompting region setting (e.g., “Please touch the region for inserting your face”), a button Bt1 to “Add regions”, and a button Bt2 to “Change headcount” are shown in addition to a touch trail L forming the region E. Then, the process proceeds to an inquiry loop of tasks S31, S33 and S35.

Based on signals from the touch panel 32, in inquiry tasks S31, S33, and S35, respectively, judgments are made as to whether a region-setting operation has been performed by the region-setting module 44, whether the button Bt1 to “Add regions” is pressed, and whether the button Bt2 to “Change headcount” is pressed. If the response is “YES” in inquiry task S33, the process returns to the inquiry task S17 to repeat the same process. As a result, a region is formed within the screen of the display module 30. If the response is “YES” in inquiry task S35, a headcount-changing operation is received by the headcount-specifying module 54 via the key input device 26 and the like in task S37, and furthermore, after changing the headcount information 64 in task S39 based on the change results from task S37, the process returns to the inquiry task S31 to repeat the same process.

After the display module 30 displays a region-setting screen, drag operations via the touch panel 32 or operations (e.g., operations of a trackball and the like) via the key input device 26 may be received to move the touch trail L (region E) to an arbitrary position on the region-setting screen, or to enlarge/shrink or change the shape.

When a touch operation is performed in the region E, or when touch operations are performed in regions in order, the judgment “YES” is made in the inquiry task S31, and the process proceeds to task S41. In task S41, the set-region information 66 is generated (updated) by the region-setting module 44 based on the set results from inquiry task S31. Here, priority information according to the order in which the regions E were touched (or another operation) may also be generated. Then, the process proceeds to task S43, and an instruction is issued to the driver 28 to display a settings confirmation screen on the display module 30. On the settings confirmation screen, the region E set as described above is colored and shown. Information indicating the shutter system and headcount set as described above (“Shutter system: Automatic” and “Headcount: One person per region”) is also shown.

Based on signals from the touch panel 32, in inquiry tasks S45 and S47, respectively, judgments are made by the CPU 24 as to whether an OK operation has been performed and whether a Cancel operation has been performed. If the response is “YES” in the inquiry task S47, the process leads back to the task S1 to repeat the process 1100. On the other hand, if the response is “YES” in the inquiry task S45, the process 1100 shifts to self-portrait mode.

Although initial setting is executed each time as shown in FIGS. 11 and 12, the previous settings may be saved on the flash memory 36 and the like, and the saved details may be read by the main memory 34 during the next initial setting.

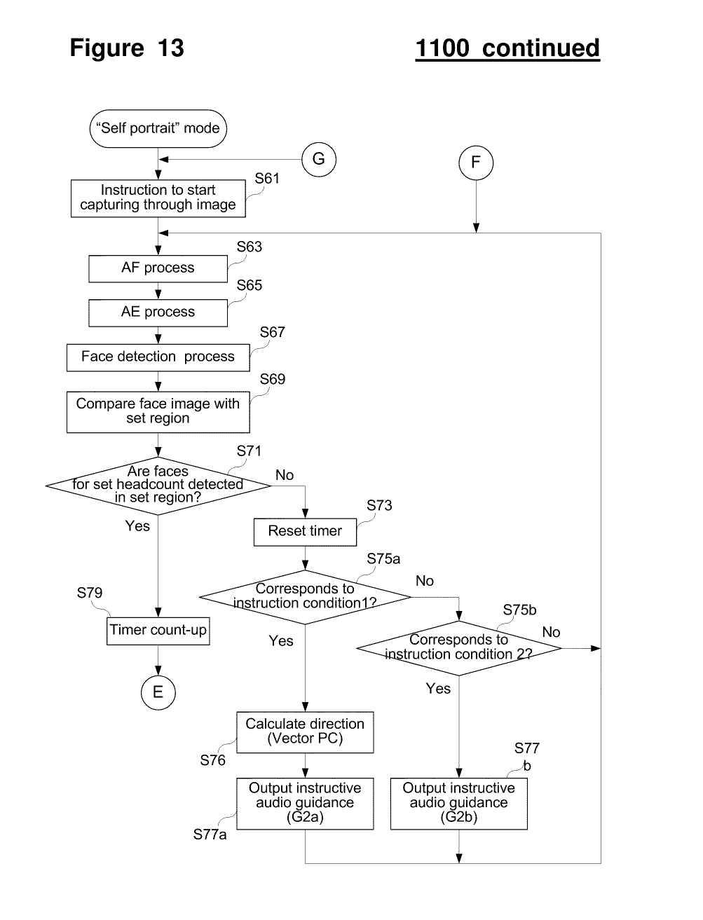

When entering self-portrait mode, the CPU 24 first issues an instruction to start through image capture in task S61 (FIG. 13). In response, the image pickup module 38 starts through image capture. In the image pickup module 38, an optical image formed on the light-receiving surface of the image sensor 38b after passing through the lens 38a undergoes photoelectric conversion, and as a result, a charge representing the optical image is generated. In through image capture, module of the charge generated in the image sensor 38b is read out as low-resolution raw image signals every 1/60 second. The read-out raw image signals are subjected to a series of image processes such as A/D conversion, color separation and YUV conversion by the camera processing circuit 38c and are converted to YUV-format image data.

As explained above, from the image pickup module 38, low-resolution image data for through display are output at a frame rate of 60 fps. The output image data are written into the main memory 34 as the current through image data 69. The driver 28 repeatedly reads out the through image data 69 stored in the main memory 34, and displays a through image based thereon in the display module 30.

In tasks S63 and S65, by referring to the through image data 69 stored in the main memory 34, an AF process for adjusting the position of the lens 38a to the optimal position via the driver 38d and an AE process for adjusting the exposure amount of the image sensor 38b to the optimal amount are executed, respectively. When executing the AF process and the AE process, the set region E may be prioritized by referring to the set-region information 66. If multiple regions E1, E2, . . . are set, the priority (priority level) set for each region E1, E2, . . . may be considered.

In task S67, a face detection process is executed by the face detection module 46 based on the through image data 69 and the face DB 80 stored in the main memory 34. In the face detection process, a process of moving the detection frame relative to the through image data 69 of one frame, cutting out the module within this frame, and comparing the image data of the cut-out module with the face DB 80 is repeatedly performed. When executing the face detection process, the set region E may again be prioritized, and the priority level set for each region E1, E2, . . . may be considered.

Face detection may be performed by starting from the set region E (each region E1, E2, . . . ) and expanding the detection range to the surrounding area (by moving the detection frame in a spiral), or decreasing the size of the detection frame in the set region E (each region E1, E2, . . . ) and its surroundings (to raise the accuracy of detection). When the face F is detected, a face ID is assigned and the position (coordinates of the center point P), size (a×b), pupil distance (d), mouth-corner positions, eye-corner positions and the like are calculated. These calculated results are written into the main memory 34 as the face information 70.

In task S69, based on the set-region information 66 and the face information 70, the face F (F1, F2, . . . ) is compared with the set region E (E1, E2, . . . ). In the following inquiry task S71, a judgment is made as to whether the number of faces F (F1, F2, . . . ) equivalent to the set headcount has been detected within the set region E (E1, E2, . . . ).

In cases in which the number of set regions is one and the set headcount is one person per region, if the entirety of the face F is within the set region E (E1, E2, . . . ), the judgment “YES” is made by the decision module 48 in the inquiry task S71. On the other hand, if the entirety of the face F is outside the set region E (E1, E2, . . . ), or if only module of the face F is within the set region E (E1, E2, . . . ), the judgment “NO” is made in the inquiry task S71. A method may be used in which, if at least a set proportion (e.g., 50%) of the face F is within the set region E (E1, E2, . . . ), the judgment “YES” is made by the decision module 48 in the inquiry task S71, and if less than the set proportion (e.g., 50%) of the face F is within the set region E (E1, E2, . . . ), the judgment “NO” is made by the decision module 48.

The proportion described here is a proportion related to the area of the skin-color region composing the face F, but it may also be a proportion related to the number of characteristic points included in the face F. If focusing on the characteristic points, there is a method in which, if 90% or more of the main characteristic points such as the eyes and the mouth are within the set region E (E1, E2, . . . ), the judgment “YES” is made in the inquiry task S71, and if less than 90% is within the set region E (E1, E2, . . . ), the judgment “NO” is made.

In cases in which the number of set regions is two or more and the set headcount is one person per region, if the entire face F1, F2, . . . is within each of the set regions E1, E2, . . . , the judgment “YES” is made in the inquiry task S71. On the other hand, if there is even one set region in which the face is not included or only module of the face is included, the judgment “NO” is made in the inquiry task S71. In this case, a method may be used in which, if 50% or more of each face is within their respective set region, the judgment “YES” is made in the inquiry task S71, and if there is even one set region in which the face is not included or less than 50% is included, the judgment “NO” is made in the inquiry task S71.

In cases in which the number of set regions is one and the set headcount is two people per region or more, if the number of faces F1, F2, . . . equivalent to the set headcount is within the set region E, the judgment “YES” is made in the inquiry task S71. On the other hand, if the number of faces within the set region E does not meet the set headcount, the judgment “NO” is made in the inquiry task S71. If the number of set regions is two or more, each region of E1, E2, . . . is verified to determine whether the number of faces equivalent to the set headcount is included, and if the number of faces equivalent to the set headcount is included in all regions E1, E2, . . . , the judgment “YES” is made in the inquiry task S71. On the other hand, if there is even one set region in which no faces are included or only module is included, the judgment “NO” is made in the inquiry task S71. In this case as well, a threshold value such as 50% may be used for judgment.

If the judgment “NO” is made in the inquiry task S71, in task S73, the timer information 72 is reset (reset to “T=0”). Next, while referring to the instruction-conditions information 76, a judgment is made as to whether the comparison results from task S69 correspond to either of the instruction conditions 1 or 2 described above. Specifically, a judgment is made in inquiry task S75a as to whether the results correspond to the instruction condition 1, and if the response is “NO”, another judgment is made in inquiry task S75b as to whether the results correspond to the instruction condition 2. The instruction conditions 1 and 2 have been described above.

If the judgment “YES” is made in the inquiry task S75a, in task S76, the direction (vector PC shown in FIG. 17) from the center P of the face F toward the center C of the set region E is calculated, and in task S77a, the instructive audio guidance G2a (see FIG. 3B) comprising guidance toward the calculated direction (“right”) is (partially and sequentially) output from among the audio-guidance information 74. On the other hand, if the judgment “YES” is made in the inquiry task S75b, in task S77b, the instructive audio guidance G2b (refer FIG. 7A) including guidance to distance the face from the mobile terminal 10 is (partially and sequentially) output from among the audio-guidance information 74. After output, the process returns to the task S63 and the same process is repeated for each frame.

Consequently, if the state in which the comparison results from the task S69 correspond to either of the instruction conditions 1 or 2 is maintained, as a result of the repetition of the task S77a or S77b, the entirety of the instructive audio guidance G2a is output. The user is able to adjust the position and orientation of their face relative to the image pickup module 38 by following the instructive audio guidance G2a.

When the number of faces F (F1, F2 . . . ) equivalent to the set headcount is comprised in the set regions E (E1, E2 . . . ) as a result of such adjustments, the judgment result in S71 changes from “NO” to “YES”, and the process of the CPU 24 moves to task S79. In the task S79, the timer information 72 counts up (add 1/60 second based on signals from the RTC 24a; T=T+ 1/60 second), and then, the process proceeds to task S81.

Referring FIG. 14, in the task S81, in order to judge the currently selected shutter system, the shutter-system information 62 is read from the main memory 34 by the CPU 24. Next, a judgment is made by the decision module 48 or by the CPU 24 in inquiry task S83 as to whether the read shutter-system information indicates manual shutter, and if the result is “NO”, another judgment is made by the decision module 46 or by the CPU 24 in inquiry task S85 as to whether it is smile shutter. If the result here is also “NO”, the currently selected shutter system is deemed to be automatic shutter, and the process 1100 proceeds to task S87. In the task S87, voice guidance G1 for automatic shutter is (partially and sequentially) output by the first guidance output module 50 from among the audio-guidance information 74.

Next, in inquiry task S89, a judgment is made as to whether the time (T) indicated by the timer information 78 has reached a predefined time (e.g., 4 seconds), and if the result is “NO” (e.g., T<4 seconds), the process returns to S63 and the same process is repeated for each frame. If the result is “YES” (e.g., T≧4 seconds) in the inquiry task S89, the process proceeds to task S99.

If the result is “YES” in the inquiry task S83, in task S91, audio guidance G3 or G4 for manual shutter is (partially and sequentially) output from among the audio-guidance information 74. Next, in S93, based on signals from the key input device 26 (or the touch panel 32), a judgment is made as to whether a shutter operation has been performed, and if the result is “NO”, the process returns to the task S63 and the same process is repeated for each frame. If the result is “YES” in inquiry task S93, the process proceeds to task S99.

If the result is “YES” in the inquiry task S85, in task S95, audio guidance G5 for smile shutter is (partially and sequentially) output from among the audio-guidance information 74. Next, in inquiry task S97, a judgment is made as to whether the smile conditions have been satisfied based on the face information 70 (particularly the mouth-corner positions and eye-corner positions), and if the result is “NO” (e.g., “The corners of the mouth are not raised, and the corners of the eyes are not lowered”), the process returns to the task S63 and the same process is repeated for each frame. If the result is “YES” (e.g., “The corners of the mouth are raised, and/or the corners of the eyes are lowered”) in inquiry task S97, the process proceeds to task S99.

In the task S99, an instruction to capture a still image is issued. In response, the image pickup module 38 executes still-image capture. In the image pickup module 38, an optical image formed on the light-receiving surface of the image sensor 38b through the lens 38a undergoes photoelectric conversion, and as a result, a charge representing the optical image is generated. In still-image capture, the charge generated in the image sensor 38b in this way is read out as high-resolution raw image signals. The read-out raw image signals are subjected to a series of image processes such as A/D conversion, color separation, YUV conversion and the like by the camera processing circuit 38c, and are converted to YUV-format image data.

In this manner, high-resolution image data for recording are output from the image pickup module 38. The output image data are temporarily stored in the main memory 34. Next, in task S101, the image data temporarily stored in the main memory 34 are written into the flash memory 36 as still-image data. Next, in inquiry task S103, based on signals from the key input device 26 (or the touch panel 32), a judgment is made by the CPU 24 as to whether an end operation has been performed, and if the result is “NO”, the process returns to the task S61 and the same process is repeated. If the result is “YES” in the inquiry task S103, the image pickup process for self-portrait mode ends.

The image pickup module 38 repeatedly captures a through image (the task S61) until the shutter conditions are satisfied, and captures a still image (the task S99) when the shutter conditions are satisfied (“Yes” in the inquiry tasks S89, S93, S97). The shutter conditions may comprise, for example but without limitation, a predefined time has passed since the face F entered the region E, a shutter operation has been performed, the face F is showing the characteristics of a smiling face, and the like. In the display module 30, the through image captured by the image pickup module 38 is at least displayed via the driver 28.

The CPU 24 sets a desired region E on the display surface of the display module 30 (the tasks S15 to S33 and S41 to S47) and detects the face F on the through image captured by the image pickup module 38 (the task S67), and if the face F is detected within the set region E (“Yes” in the inquiry task S71), it judges whether the shutter conditions have been satisfied (“Yes” in the inquiry tasks S89, S93, S97). Still-image capture performed by the image pickup module 38 is executed by referring to this judgment result.

Consequently, whether the shutter conditions have been satisfied is judged by the decision module 48 while the face F is within the region E, and still-image capture is performed if the conditions are satisfied, and a result, a still image in which the face F is arranged within the region E is captured. As a result, when taking a self-portrait, even if the through image cannot be seen, it is possible to capture a still image in which the face F is arranged within the desired region E.

The image pickup module 38 and/or the display module 30 may be separate units from the housing H, or may be detachable from the housing H or have variable orientations. In any case, without being limited to self-portraits, it is possible to capture a still image in which one's face is arranged within a desired region even when it is difficult to see the through image.

The touch panel 32 is provided on the display surface of the display module 30 and is a device for specifying an arbitrary position on the display surface (or detecting a specified position), and may also be referred to as a touch screen, a tablet, or the like. The CPU 24 may perform region setting through the key input device 26 instead of the touch panel 32, or may use a combination of the two. One or two or more regions may be selected from among multiple preliminarily determined regions through cursor operations on the key input device 26. Region setting may be performed using an input module other than the touch panel 32 or the key input device 26 that has been attached to the mobile terminal 10, or an external pointing device such as a mouse or a touchpad, an external keyboard or the like.

If the face F is detected within the set region E (“Yes” in the task S71), the CPU 24 outputs the audio guidance such as G1 and G3 to G5 that at least comprises a notification that the face F is positioned within the region E (the tasks S87, S91, S95).

Instead of being output from the speaker 22 in the form of audio guidance based on language, the audio guidance such as G1 and G3 to G5 may be output in the form of a signal tone, such as for example but without limitation, bell sound, buzzer sound, high-pitched sound, low-pitched sound, and the like or may be output from the light-emitting device 40 in the form of a signal light, such as for example but without limitation, red light, blue light, lights that blink in various patterns, and the like.

Because the user knows that the face F has entered the set region E due to such audio guidance such as G1 and G3 to G5, they are able to prepare for the still-image capture by staying still, making a smile or the like.

If the detected face F is protruding from the set region E (“Yes” in the inquiry tasks S75a and S7b), the second guidance output module 48 such as the speaker 22 outputs the audio guidance G2a and G2b for including the face F within the region E (the tasks S77a and S77b).

Depending on the content, instead of being output from the speaker 22 in the form of audio guidance based on language, the audio guidance G2a and G2b may be output in the form of a signal tone, or may be output from the light-emitting device 40 in the form of a signal light. If the light-emitting device 40 comprises multiple light-emitting elements (e.g., LEDs) arranged two-dimensionally, it is also possible to indicate direction.

As a result of such audio guidance G2a and/or G2b, the user is able to easily insert the face F within the region E.

If the detected face F is too small for the set region E, an audio guidance prompting the user to come closer to the image pickup module 38 may be output.

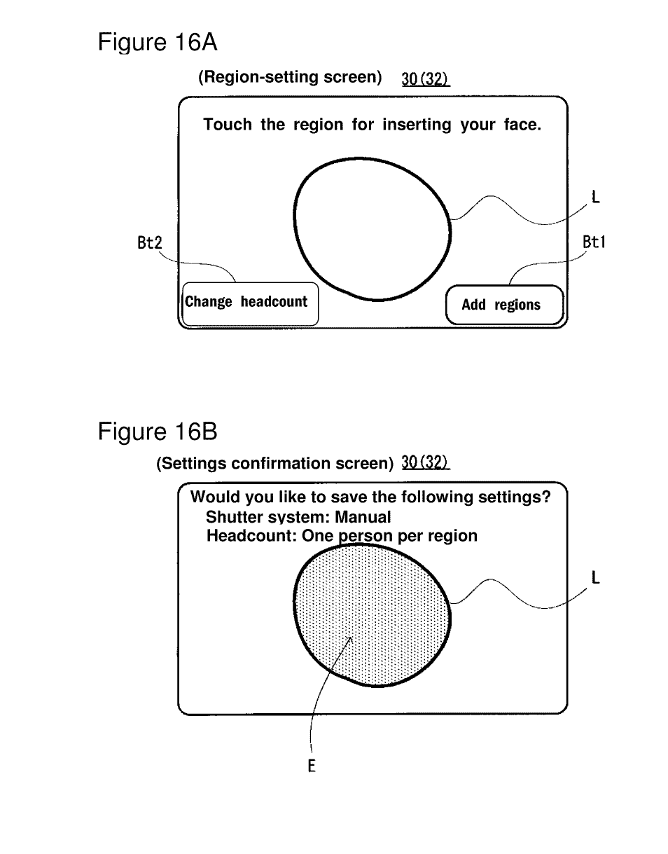

FIGS. 15 and 16 are illustrations showing exemplary display screens according to embodiments of the disclosure.

FIG. 17 is an illustration showing various variables for deciding whether a face is inside a region. The variables A and B indicate the vertical size (length in x-direction) and horizontal size (length in y-direction) of the set region E respectively, and the variables a and b indicate the vertical size and horizontal size of the face F (having a skin-color region) respectively. The variable d indicates a distance between the two pupils, the point C represents a center (center of gravity) of the set region E, and the point P represents the center of the face F (the midpoint of the two pupils, or the center of gravity of a skin-color region). The size of the face F may be expressed as the distance d between the pupils. In this case, for example but without limitation, the instruction condition 2 states that “The distance d between the pupils is greater than ⅓ of the horizontal size b of the set region E” (i.e., 3d>b), and the like.

In this embodiment, a still image is captured in response to the shutter conditions being satisfied, but a moving image for recording may be captured in response to the shutter conditions being satisfied. As a result, even when the through image cannot be seen when taking a self-portrait, it is possible to capture a moving image in which the face F is arranged within the desired region E. If the face F leaves the region E during moving-image capture, it is preferable to provide notification of the fact. Instead of such notification, or in addition, guidance information for reinserting the face F within the region E, or information similar to the information G2a and G2b within the instructive audio guidance may be output. During the period that the face F is outside the region E, the moving-image capture may be discontinued to execute through image capture.

Various embodiments are described above for obtaining still images with a face at an intended position and size. However, embodiments of the disclosure can also be used for obtaining still images with any object at an intended position and size. The object may comprise any item of interest, for example but with limitation, buildings, vehicles, views, body parts, flowers, plants, and the like.

FIGS. 18A is an illustration of an audio guidance during capture of a self-portrait using the image pickup module 38 according to an embodiment of the disclosure.

FIGS. 18B is an illustration of an audio guidance during capture of a self-portrait using the image pickup module 38.

In this document, the terms “computer program product”, “computer-readable medium”, and the like may be used generally to refer to media such as, for example, memory, storage devices, or storage unit. These and other forms of computer-readable media may be involved in storing one or more instructions for use by the CPU 24 to perform specified operations. Such instructions, generally referred to as “computer program code” or “program code” (which may be grouped in the form of computer programs or other groupings), when executed, enable the data sorting method of the system 10.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. An image pickup device, comprising:
an image pickup module operable to:
repeatedly capture a plurality of through images; and
capture an image for recording in response to a satisfied shutter condition signal;
a display module comprising a screen, and operable to display the through images;
a region-setting module operable to set a face-capture region on the screen;
a face detection module operable to detect a face in the through images; and
a decision module operable to decide whether a shutter condition is satisfied, and signal the satisfied shutter condition signal, if the face is within the face-capture region.

2. The image pickup device according to claim 1, wherein the image for recording comprises a still image.

3. The image pickup device according to claim 1, wherein:
the display module comprises a touch panel; and
the region-setting module is further operable to set the face-capture region via the touch panel.

4. The image pickup device according to claim 1, further comprising a guidance output module operable to output guidance information.

5. The image pickup device according to claim 4, wherein the guidance information comprises a notification that the face is positioned within the face-capture region, if the face is within the face-capture region.

6. The image pickup device according to claim 4, wherein the shutter condition comprises a condition that a shutter operation has been performed.

7. The image pickup device according to claim 6, wherein the guidance information comprises guidance that prompts the shutter operation.

8. The image pickup device according to claim 4, wherein the guidance information comprises guidance related to a time that a face is detected in the face-capture region.

9. The image pickup device according to claim 4, wherein the guidance information comprises guidance that prompts a smile.

10. The image pickup device according to claim 4, wherein the guidance information comprises guidance for placing the face into the face-capture region, if a face detected by the face detection module is outside the face-capture region.

11. The image pickup device according to claim 1, further comprising a headcount-specifying module operable to specify a headcount, wherein the decision module is operable to determine whether a number of faces equivalent to the headcount is detected within the face-capture region.

12. The image pickup device according to claim 1, wherein the shutter condition comprises a condition that a face is detected in the face-capture region for a predefined time.

13. The image pickup device according to claim 1, wherein the shutter condition comprises a condition that the face detected in the face-capture region comprises a smiling face.

14. A method for picking up an image, comprising:
capturing through images repeatedly until a shutter condition is satisfied;
detecting an object in the through images;
deciding whether the shutter condition is satisfied, if the object is within a face-capture region of at least one of the through images; and
capturing an image for recording, if the shutter condition is satisfied.

15. The method for picking up an image according to claim 14, wherein the object comprises at least one member selected from the group consisting of: a face and a body part.

16. A computer-readable medium for capturing an image for recording, the computer-readable medium comprising program code for:
capturing through images repeatedly until shutter condition is satisfied;
detecting a face in the through images;
deciding whether the shutter condition is satisfied, if the face is within a face-capture region on the through images; and
capturing an image for recording, if the shutter condition is satisfied.

17. An image pickup device, comprising:
an image pickup module operable to capture through images and a still image;
a display module comprising a screen, and operable to display the through images repeatedly on the screen; and
a memory module operable to store the still image, if a face of a person to be captured is inside a face-capture region on the screen.

18. The image pickup device according to claim 17, further comprising a face detection module operable to detect the face of the person.

19. The image pickup device according to claim 17, further comprising a region-setting module operable to set the face-capture region on the screen.

20. The image pickup device according to claim 17, wherein the memory module is further operable to store the still image, if a test condition is true, wherein the test condition comprises at least one member of the group consisting of: a shutter is pressed, the face remains in the face-capture region for a predefined time, and the face inside the face-capture region comprises a smiling face.
